(19) United States
(12) Patent Application Publication
(10) Pub. No.: US 2009/0012245 A1
(43) Pub. Date: Jan. 8, 2009

(54) CARBONYL HYDROGENATED KETONE ALDEHYDE RESINS, DEVOID OF FORMALDEHYDE, BASED ON FORMALDEHYDE AND ASSOCIATED PRODUCTION METHOD

(75) Inventors: Patrick Glockner, Haltern am See (DE); Andreas Wenning, Nottuln (DE); Christian Lettmann, Coesfeld (DE); Peter Denkinger, Nottuln (DE)

Correspondence Address: OBLON, SPIVAK, MCCLELLAND MAIER & NEUSTADT, P.C., 1940 DUKE STREET, ALEXANDRIA, VA, 22314, US

(73) Assignee: EVONIK DEGUSSA GmbH, Essen (DE)

(21) Appl. No.: 12/159,906

(22) PCT Filed: Nov. 28, 2006
(86) PCT No.: PCT/EP2006/068972

§ 371 Date: Jul. 2, 2008

(30) Foreign Application Priority Data
Feb. 28, 2006 (DE) 10 2006 009 079.9

(51) Int. Cl. C08F 2/01; C08G 6/02

(52) U.S. Cl. 526/64; 528/227; 528/222; 528/224; 528/223

(57) ABSTRACT

The invention relates to formaldehyde-free, carbonyl-hydrogenated ketone-aldehyde resins based on formaldehyde and having a low fraction of crystallizable compounds, low viscosity, very low color number, and very high heat stability and light stability, and also to a process for preparing them.

The invention relates to formaldehyde-free, carbonyl-hydrogenated ketone-aldehyde resins based on formaldehyde and having a low fraction of crystallizable compounds, low viscosity, very low color number, and very high heat stability and light stability, and also to a process for preparing them.

It is known that ketones or mixtures of ketones and aldehydes can be reacted in the presence of basic catalysts or acids to form resinous products. For instance, mixtures of cyclohexanol and methylcyclohexanone can be used to prepare resins (Ullmann Vol. 12, p. 551). The reaction of ketones and aldehydes usually results in hard resins, which are often employed in the coatings industry.

Industrially significant ketone-aldehyde resins are nowadays usually prepared using formaldehyde.

Ketone-formaldehyde resins are well established. Preparation processes are described for example in DE 33 24 287, U.S. Pat. No. 2,540,885, U.S. Pat. No. 2,540,886, DE 11 55 909, DD 12 433, DE 13 00 256, and DE 12 56 898.

The preparation normally involves reacting ketones with formaldehyde in the presence of bases.

Ketone-aldehyde resins are employed in coating materials as, for example, film-forming addition components, in order to enhance certain properties such as rate of initial dry, gloss, hardness or scratch resistance. On account of their relatively low molecular weight typical ketone-aldehyde resins possess a low melt viscosity and solution viscosity and are therefore used as film-forming functional fillers, among other things, in coating materials.

As a result, for example, of exposure to sunlight, for example, the carbonyl groups of the ketone-aldehyde resins are subject to conventional degradation reactions, such as those of Norrish type I or II, for example [Laue, Plagens, Namen- und Schlagwort-Reaktionen, Teubner Studienbucher, Stuttgart, 1995].

It is therefore not possible to use unmodified ketone-aldehyde resins or ketone resins for high-quality applications in the exterior sector, for example, where high resistance properties, particularly in respect of weathering and heat, are required. These disadvantages can be remedied by hydrogenating the carbonyl groups. The conversion of the carbonyl groups into secondary alcohols by hydrogenation of ketone-aldehyde resins has been practiced for a long time (DE 826 974, DE 870 022, JP 11012338, U.S. Pat. No. 6,222,009).

The preparation of carbonyl-hydrogenated and ring-hydrogenated ketone-aldehyde resins on the basis of ketones which contain aromatic groups is likewise possible. Resins of this kind are described in DE 33 34 631.

As demonstrated by comprehensive findings of our own, a feature common to all of these hydrogenated products is a relatively high free formaldehyde content. The hydrogenation processes described by the prior art do reduce the free formaldehyde fraction as compared with that of unhydrogenated ketone-formaldehyde resins, but there remain significant amounts of free formaldehyde in the hydrogenation products. Higher temperatures during the hydrogenation can lead to a further-reduced formaldehyde content, but may also have deleterious consequences for other resin properties, such as color, melting ranges, OH numbers, etc.

Formaldehyde may give rise to physiological damage. At the present time, however, no precise classification has been undertaken. The International Agency for Research on Cancer (IARC), and institution of the World Health Organization (WHO), recently found, on the basis of a study, that formaldehyde induces nasopharyngeal cancer, which occurs very rarely on a spontaneous basis, in humans.

Although the IARC evaluation is purely scientific and as yet does not give rise to any direct legal consequences, the provision of formaldehyde-free products is nevertheless vital in the spirit of “sustainable development” and “responsible handling of chemicals”. Moreover, it is assumed that in the medium term there will only be formaldehyde-free products on the market.

A method of lowering the formaldehyde content of nonhydrogenated acetone-formaldehyde resins without reducing the carbonyl groups is described in U.S. Pat. No. 5,247,066. There a free formaldehyde content of below 0.4% is reached, although by present-day yardsticks this is significantly too high.

The processes set out in patents DE 826 974, DE 870 022, JP 11012338, U.S. Pat. No. 6,222,009, and DE 33 34 631 lead to products which possess color, heat-stability and light-stability properties that are improved over those of the starting materials. From a present-day standpoint these products, in spite of their improvement, are no longer adequate.

Ketone-aldehyde resins have long been used to increase the nonvolatiles content of coating materials. Under the compulsion of new directives such as, for example, EU Council Directive 1999/13/EC on the limiting of emissions of volatile organic compounds it is necessary to achieve further improvements in these properties.

During the synthesis of ketone-formaldehyde resins it is possible for crystallizable compounds to be formed, which are primarily cyclic oligomers. If the carbonyl groups of these secondary components are hydrogenated, the resulting products tend to crystallize in solution (formula I), which in coating materials can lead to processing disadvantages.

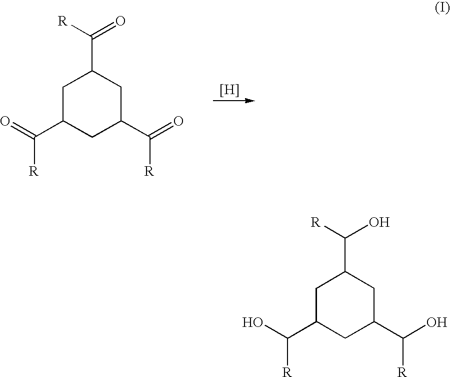

It was an object of the present invention, therefore, to find carbonyl-hydrogenated ketone-aldehyde resins based on formaldehyde that are free from free formaldehyde. The fraction of crystallizable compounds ought to be as low as possible. Furthermore, the properties of the resins in terms of solution viscosity in tamden with high melting range and color ought to be improved further, and there ought to be a very high heat stability and light stability.

It was a further object of the present invention to develop a process for preparing such products.

Surprisingly it has been possible to achieve this object in accordance with the claims, by reacting specially prepared ketone-aldehyde resins based on formaldehyde with hydrogen in the presence of catalysts which on the one hand selectively hydrogenate the carbonyl groups of the resins and on the other hand reduce the free formaldehyde. It has been found that a particularly low number of carbonyl groups is particularly advantageous.

The ketone-aldehyde resins carbonyl-hydrogenated in accordance with the invention possess outstanding light stability and heat stability and a very low color. The products possess a low fraction of carbonyl groups and of crystallizable compounds, and are virtually free from formaldehyde. Despite the high melting range, and in contrast to the prior art, the solution viscosity is low and can be realized through the use of tailored starting resins for the hydrogenation that possess a particularly narrow molecular weight distribution.

The invention provides carbonyl-hydrogenated ketone-aldehyde resins based on formaldehyde, having a free formaldehyde content of less than 3 ppm, which contain substantially the structural elements of formula II

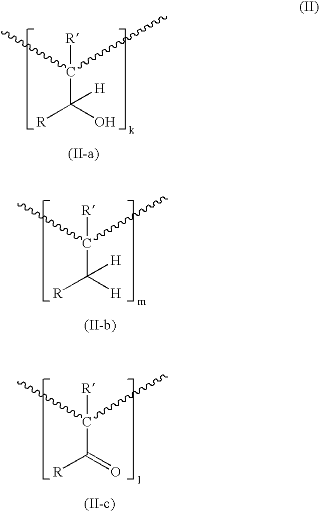

where
R is aromatic with 6-14 carbon atoms or (cyclo)aliphatic with 1-12 carbon atoms,

### R′ is H or CH₂OH,

k is 2 to 15, preferably 3 to 12, more preferably 4 to 12,
m is 0 to 13, preferably 0 to 9,
l is 0 to 2,
the sum of k+l+m being from 5 to 15 and k being >m, preferably between 5 and 12, the three structural elements possibly being distributed alternately or randomly, and the structural elements being linked linearly via CH₂ groups and/or with branching via CH groups.

The invention provides carbonyl-hydrogenated ketone-aldehyde resins based on formaldehyde, having a free formaldehyde content of less than 3 ppm, which contain substantially the structural elements of formula II

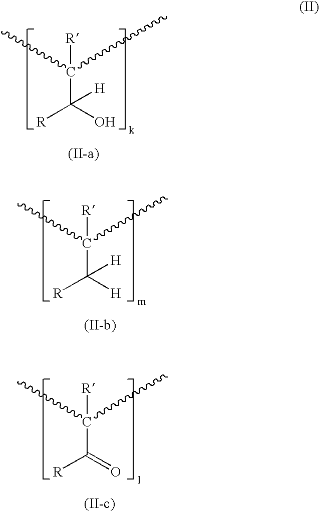

where
R is aromatic with 6-14 carbon atoms or (cyclo)aliphatic with 1-12 carbon atoms,

### R′ is H or CH₂OH,

k is 2 to 15, preferably 3 to 12, more preferably 4 to 12,
m is 0 to 13, preferably 0 to 9,
l is 0 to 2,
the sum of k+l+m being from 5 to 15 and k being >m, preferably between 5 and 12, the three structural elements possibly being distributed alternately or randomly, and the structural elements being linked linearly via CH₂ groups and/or with branching via CH groups,
obtained by
A) preparing the base resin by condensing at least one ketone with at least one aldehyde in the presence of at least one basic catalyst and, if desired, of at least one phase transfer catalyst, solventlessly or using a water-miscible organic solvent,
   and subsequently
B) subjecting the carbonyl groups of the ketone-aldehyde resins (A) to continuous, semibatchwise or batchwise hydrogenation in the melt or in solution in a suitable solvent with hydrogen in the presence of a catalyst at pressures from 50 to 350 bar, preferably from 100 to 300 bar, more preferably from 150 to 300 bar, and at temperatures from 40 to 140° C., preferably from 50 to 140° C.

The invention preferredly provides carbonyl-hydrogenated ketone-aldehyde resins, based on formaldehyde, characterized in that
the free formaldehyde content is below 3 ppm, preferably below 2.5 ppm, more preferably below 2.0 ppm,
the amount of crystallizable compounds is below 5%, preferably below 2.5%, more preferably below 1%, by weight,
the carbonyl number is from 0 to 100 mg KOH/g, preferably from 0 to 50 mg KOH/g, more preferably from 0 to 25 mg KOH/g,
the hydroxyl number is from 50 to 450 mg KOH/g, preferably from 150 to 400 mg KOH/g, more preferably from 200 to 375 mg KOH/g,
the Gardner color number (50% in ethyl acetate) is below 1.5, preferably below 1.0, more preferably below 0.75,
the Gardner color number (50% in ethyl acetate) after thermal exposure of the resin (24 h, 150° C.) is below 2.0, preferably below 1.5, more preferably below 1.0, the polydispersity (Mw/Mn) of the resins is from 1.35 to 1.6, more preferably from 1.4 to 1.58,
the solution viscosity, 40% strength in phenoxyethanol, is from 5000 to 12 000 mPa·s, more preferably from 6000 to 10 000 mPa·s,
the melting point/range is from 50 to 150° C., preferably from 75 to 140° C., more preferably from 100 to 130° C.,
the amount of nonvolatile constituents after heating at 150° C. for 24 h is more than 97.0%, preferably more than 97.5%.

The invention also provides a process for preparing formaldehyde-free, carbonyl-hydrogenated ketone-aldehyde resins based on formaldehyde, which substantially contain the structural elements of formula II, said process comprising
A) preparing the base resins by condensing at least one ketone with at least one aldehyde in the presence of at least one basic catalyst and, if desired, of at least one phase transfer catalyst, solventlessly or using a water-miscible organic solvent,
   and subsequently
B) subjecting the carbonyl groups of the ketone-aldehyde resins (A) to continuous, semibatchwise or batchwise hydrogenation in the melt or in solution in a suitable solvent with hydrogen in the presence of a catalyst at pressures from 50 to 350 bar, preferably from 100 to 300 bar, more preferably from 150 to 300 bar, and at temperatures from 40 to 140° C., preferably from 50 to 140° C.

As a result of the process of the invention it is possible sharply to reduce the amount of physiologically harmful formaldehyde. Formaldehyde-free means that the carbonyl-hydrogenated ketone-aldehyde resins of the invention possess a free formaldehyde content of less than 3 ppm, preferably less than 2.5 ppm, more preferably less than 2.0 ppm.

The process of the invention very substantially prevents the formation of crystallizable compounds. The amount of crystallizable compounds in the products of the invention is below 5%, preferably below 2.5%, more preferably below 1%, by weight. As a result it is possible always to prepare clear solutions of the products of the invention. This is particularly important with a view to preventing clogging of, for example, spraygun nozzles or ballpoint pen reservoirs.

It has been found that a low color number and a high thermal stability are the result of a low carbonyl number (l<2 from II-c). The carbonyl number of the products of the invention is from 0 to 100 mg KOH/g, preferably from 0 to 50 mg KOH/g, more preferably from 0 to 25 mg KOH/g, so that the Gardner color number (50% in ethyl acetate) of the products of the invention is below 1.5, preferably below 1.0, more preferably below 0.75, and the Gardner color number (50% in ethyl acetate) after thermal exposure of the products of the invention (24 h, 150° C.) is below 2.0, preferably below 1.5, more preferably below 1.0.

A very low solution viscosity is desirable so that the fraction of organic solvents, needed, among other things, in order to lower the solution viscosity into the desired processing range, is as low as possible, on the basis of economics and of environmental protection. The solution viscosity of the products of the invention, 40% strength in phenoxyethanol, is from 5000 to 12 000 mPa·s, more preferably from 6000 to 10 000 mPa·s.

For a given molecular weight (Mn), the greater the nonuniformity of the dissolved polymer (high polydispersity) the higher the solution viscosity. The resins of the invention possess low polydispersities (Mw/Mn) of from 1.35 to 1.6, more preferably from 1.4 to 1.58.

A very high melting range on the part of the resins of the invention is desirable so that, for example, the rate of initial dry of the coating materials, and the hardness of the coatings, are as high as possible.

One way of obtaining a high melting point/range is via a high molecular weight (sum of k+l+m in formula II). The higher molecular weight, however, the higher the solution viscosity as well. Consequently it was desirable to raise the melting point/range without increasing the molecular weight. It proved possible to achieve this by making k in formula II always predominant and selecting it preferably to be as high as possible. The value of k is 2 to 15, preferably 3 to 12, more preferably 4 to 12. The resins of the invention possess melting points/ranges from 50 to 150° C., preferably from 75 to 140° C., more preferably from 100 to 130° C.

A high k in accordance with formula II also has a positive effect on the solubility of the resins of the invention in polar solvents such as alcohols, for example. Therefore k is selected such that k is greater than m and such that the hydroxyl number is from 50 to 450 mg KOH/g, preferably from 150 to 400 mg KOH/g, and more preferably from 200 to 375 mg KOH/g.

The solubility properties can be adjusted by way of the relationship between k, l, and m. The higher, for example, k, and the lower m and l, the more soluble the resins of the invention in polar solvents such as alcohols, for example. On the other hand, the relationship between k, l, and m must be selected such that further properties, such as the water resistance, are not adversely affected.

The values of k, l, and m and also the sum of the values may take on whole numbers, 2 for example, or else values inbetween, such as 2.4, for example.

### Components for Preparing the Base Resins A)

### Ketones and Aldehydes

Suitable ketones for preparing the carbonyl-hydrogenated ketone-aldehyde resins based on formaldehyde include all ketones, especially all α-methyl ketones possessing no reaction facility in the position α′ to the carbonyl group or exhibiting only low reactivity in the α′ position, such as acetophenone, acetophenone derivatives such as hydroxyacetophenone, alkyl-substituted acetophenone derivatives having 1 to 8 carbon atoms on the phenyl ring, methoxyacetophenone, 3,3-dimethylbutanone, methyl isobutyl ketone or else propiophenone, alone or in a mixture. These ketones, especially the α-methyl ketones, are present at from 70 to 100 mol %, based on the ketone component, in the resins of the invention.

Preference is given to carbonyl-hydrogenated ketone-aldehyde resins based on the ketones acetophenone, 3,3-dimethylbutanone, and methyl isobutyl ketone, alone or in a mixture.

In addition it is possible to use further CH-acidic ketones to a minor extent in a mixture with the abovementioned ketones, at up to 30 mol %, preferably up to 15 mol %, based on the ketone component, such as acetone, methyl ethyl ketone, heptan-2-one, pentan-3-one, cyclopentanone, cyclododecanone, mixtures of 2,2,4- and 2,4,4-trimethylcyclopentanone, cycloheptanone, and cyclooctanone, cyclohexanone and all alkyl-substituted cyclohexanones having one or more alkyl radicals which have in total 1 to 8 hydrocarbon atoms, individually or in a mixture. Examples of alkyl-substituted cyclohexanones that may be mentioned include 4-tert-amylcyclohexanone, 2-sec-butylcyclohexanone, 2-tert-butylcyclohexanone, 4-tert-butylcyclohexanone, 2-methylcyclohexanone, and 3,3,5-trimethylcyclohexanone. Preference is given to cyclohexanone, methyl ethyl ketone, 2-tert-butylcyclohexanone, 4-tert-butylcyclohexanone, and 3,3,5-trimethylcyclohexanone.

Suitable additional aldehyde components of the carbonyl-hydrogenated ketone-aldehyde resins based on formaldehyde include in principle, besides formaldehyde, unbranched or branched aldehydes, such as acetaldehyde, n-butyraldehyde and/or isobutyraldehyde, valeraldehyde, and dodecanal, for example. Generally speaking it is possible to use all of the aldehydes said to be suitable in the literature for ketone resin syntheses. It is preferred, however, to use formaldehyde alone. The further aldehydes can be employed in fractions from 0 to 75 mol %, preferably from 0 to 50 mol %, more preferably from 0 to 25 mol %, based on the aldehyde component. Aromatic aldehydes, such as benzaldehyde, may likewise be present at up to 10 mol % in a mixture with formaldehyde.

The required formaldehyde is typically used as an aqueous or alcoholic (e.g., methanol or butanol) solution with a strength of approximately from 20% to 40% by weight. Other use forms of formaldehyde are formaldehyde donor compounds such as para-formaldehyde and/or trioxane, for example.

Especially preferred for use as starting compounds for the carbonyl-hydrogenated resins are acetophenone, 3,3-dimethylbutanone, and methyl isobutyl ketone, and, if desired, CH-acidic ketones selected from cyclohexanone, methyl ethyl ketone, 2-tert-butylcyclohexanone, 4-tert-butylcyclohexanone, and 3,3,5-trimethylcyclohexanone, alone or in a mixture, and formaldehyde. It is also possible in this context to use mixtures of different ketone-aldehyde resins.

The molar ratio of the ketone to the aldehyde component is from 1:0.25 to 1:15, preferably from 1:0.9 to 1:5, and more preferably from 1:0.95 to 1:4.

### Process for Preparing the Carbonyl-Containing Base Resins A)

For preparing the carbonyl-containing base resins A) the respective ketone or a mixture of different ketones is reacted with formaldehyde or a mixture of formaldehyde and additional aldehydes in the presence of at least one basic catalyst. Especially when using aqueous formaldehyde solution and ketones of limited water-solubility it is possible with advantage to use water-miscible organic solvents. On account of the improved phase mixing associated with this as well as with other factors, the conversion in the reaction is in this case more rapid and more complete. Moreover it may be possible in addition, if desired, to use at least one phase transfer catalyst, permitting a reduction in the amount of alkali compound, for example. After the end of the reaction the aqueous phase is separated from the resin phase. The crude product is washed with acidic water until a melt sample of the resin appears clear. The resin is then dried by distillation.

The reaction for preparing the base resins from ketone and aldehyde is carried out in a basic medium. Generally speaking it is possible to use all of the basic catalyst said to be suitable in the literature for ketone resin syntheses, such as alkali metal compounds, for example. Preference is given to hydroxides, such as those of the cations NH₄, NR₄, Li, Na, and K, for example. Hydroxides of the cations NH₄, NR₄, Li, and Na are especially preferred.

The reaction for preparing the base resins from ketone and aldehyde can be carried out using an auxiliary solvent. Alcohols such as methanol or ethanol, for example, have proven suitable. It is also possible to use water-soluble ketones as auxiliary solvents, which in that case are incorporated into the resin by reaction as well.

In order to purify the base resins A) it is necessary to remove the basic catalyst used from the resin A). This can be done easily by washing the resin with water using acids for neutralization. In general all acids, such as all organic and/or inorganic acids, are suitable for the neutralization. Preference is given to organic acids having 1 to 6 carbon atoms, more preference to organic acids having 1 to 4 carbon atoms.

In the polycondensation mixture for preparing the base resins from ketone and aldehyde it is additionally possible, optionally, to use phase transfer catalysts.

When using a phase transfer catalyst use is made of 0.01% to 15% by weight, based on the ketone, of a phase transfer catalyst of the general formula (A)

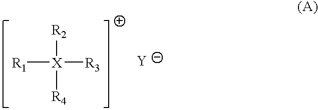

where
X is a nitrogen or phosphorus atom,
R₁, R₂, R₃, and R₄ can be identical or different and are each an alkyl radical having 1 to 22 carbon atoms in the carbon chain and/or a phenyl and/or benzyl radical,
   and
Y is the anion of an (in)organic acid or a hydroxide ion.

For the case of quaternary ammonium salts preference is given to alkyl radicals (R₁₋₄) having 1 to 22 carbon atoms, especially those having 1 to 12 carbon atoms, in the carbon chain and/or to phenyl and/or benzyl radicals and/or mixtures of both. Suitable anions include those of strong (in)organic acids such as, for example, Cl⁻, Br⁻, I⁻, and also hydroxides, methoxides or acetates. Examples of quaternary ammonium salts are cetyldimethylbenzylammonium chloride, tributylbenzylammonium chloride, trimethylbenzylammonium chloride, trimethylbenzylammonium iodide, triethylbenzylammonium chloride or triethylbenzylammonium iodide, tetramethylammonium chloride, tetraethylammonium chloride, and tetrabutylammonium chloride. Preference is given to using benzyltributylammonium chloride, cetyldimethylbenzylammonium chloride and/or triethylbenzylammonium chloride.

For quaternary phosphonium salts preference is given for R₁₋₄ to alkyl radicals having 1 to 22 carbon atoms and/or phenyl radicals and/or benzyl radicals. Suitable anions include those of strong (in)organic acids such as, for example, Cl⁻, Br⁻, and I⁻, and also hydroxides, methoxides or acetates.

Suitable quaternary phosphonium salts include triphenylbenzylphosphonium chloride or triphenylbenzylphosphonium iodide, for example. It is, however, also possible to use mixtures.

The phase transfer catalyst present if desired is used in amounts from 0.01% to 15%, preferably from 0.1% to 10.0%, and in particular in amounts from 0.1% to 5.0%, by weight, based on the ketone employed, in the polycondensation mixture.

### PARTICULARLY PREFERRED EMBODIMENT

In one particularly preferred embodiment the carbonyl-containing base resin A) is prepared first of all. For this purpose 10 mol of ketone are introduced initially in a 50% to 90% strength methanolic solution, together with 0 to 5% by mass of a phase transfer catalyst and 1 to 5 mol of an aqueous formaldehyde solution, and this initial charge is homogenized with stirring. Then 0.1 to 5 mol of an aqueous sodium hydroxide solution are added with stirring. This is followed at 70 to 115° C., again with stirring, by the addition of 4 to 10 mol of an aqueous formaldehyde solution over 30 to 120 min. The stirrer is switched off after a further 0.5 to 5 h of stirring at reflux temperature. Optionally it is possible, after about a third of the operating time, to add a further 0.1 to 1 mol of an aqueous formaldehyde solution. The aqueous phase is separated from the resin phase. The crude product is washed with water using an organic acid until a melt sample of the resin appears clear. Then the resin is dried by distillation.

Process for Preparing the Resins of the Invention in Accordance with Step B)

The resins formed from ketone and aldehyde are hydrogenated with hydrogen in the presence of a catalyst. The carbonyl groups of the ketone-aldehyde resin are converted in this hydrogenation into a secondary hydroxyl group. Depending on reaction conditions, some of the hydroxyl groups may be eliminated, resulting in methylene groups. The reaction conditions are selected such that the fraction of unreduced carbonyl groups is low. The following, simplified scheme serves for illustration:

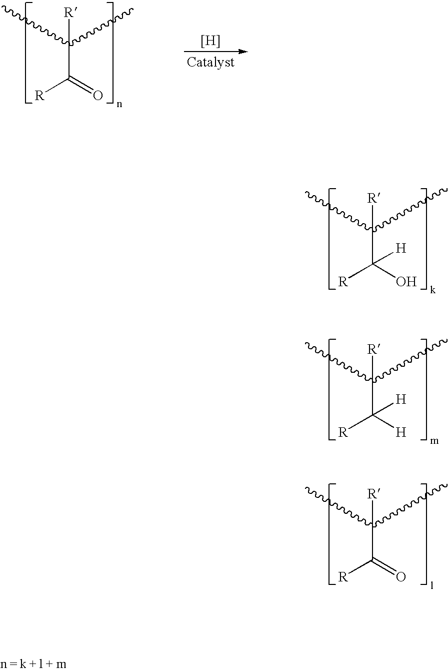

Catalysts which can be used include in principle all compounds which catalyze the hydrogenation of carbonyl groups and also the hydrogenation of free formaldehyde to methanol with hydrogen. Both homogeneous and heterogeneous catalysts can be used, particular preference being given to heterogeneous catalysts.

For the purpose of obtaining the formaldehyde-free products of the invention, metal catalysts selected from nickel, copper, copper-chromium, palladium, platinum, ruthenium, and rhodium, alone or in a mixture, have proven especially suitable, particular preference being given to nickel catalysts, copper-chromium, and ruthenium catalysts.

In order to increase the activity, selectivity and/or service life it is possible for the catalysts additionally to contain doping metals or other modifiers. Examples of typical doping metals are Mo, Fe, Ag, Cr, Ni, V, Ga, In, Bi, Ti, Zr, and Mn, and also the rare earths. Examples of typical modifiers are those which can be used to influence the acid-based properties of the catalysts, such as alkali metals and alkaline earth metals and/or compounds thereof and also phosphoric acid or sulfuric acid and compounds thereof. The catalysts can be employed in the form of powders or shaped bodies, such as extrudates or compressed powders, for example. It is possible to employ solid catalysts, Raney-type catalysts or supported catalysts. Preference is given to Raney-type and supported catalysts. Suitable support materials are, for example, kieselguhr, silica, alumina, alumosilicates, titanium dioxide, zirconium dioxide, aluminum-silicon mixed oxides, magnesium oxide, and activated carbon. The active metal can be applied to the support material in a way which is known to the skilled worker, such as by impregnation, spray application or precipitation, for example. Depending on the nature of catalyst preparation, further preparation steps, known to the skilled worker, are needed, such as drying, calcining, shaping, and activation, for example. For shaping it is possible optionally to add further auxiliaries such as graphite or magnesium stearate, for example.

The catalytic hydrogenation may take place in the melt, in solution in a suitable solvent or in the hydrogenation product itself as “solvent”. The solvent used if desired can be separated off if desired after the end of reaction. The solvent separated off can be recycled to the process, with additional purification steps for complete or partial removal of light or heavy volatile byproducts, such as methanol and water, possibly being necessary, depending on the solvent used. Suitable solvents are those in which not only the reactant but also the product dissolve in sufficient amount and which behave inertly under the selected hydrogenation conditions. These solvents are, for example, alcohols, preferably n-butanol and isobutanol, cyclic ethers, preferably tetrahydrofuran and dioxane, alkyl ethers, aromatics, such as xylene, and esters, such as ethyl acetate and butyl acetate, for example. Mixtures of these solvents are also possible. The concentration of the resin in the solvent can be varied from 1% to 99%, preferably from 10% to 50%.

In order to achieve high conversions with very low reactor residence times, relatively high pressures are advantageous. The overall pressure in the reactor is from 50 to 350 bar, preferably 100 to 300 bar. The optimum hydrogenation temperature is dependent on the hydrogenation catalyst used. For instance, for rhodium catalysts temperatures of from just 40 to 75° C., preferably from 40 to 60° C., are sufficient, whereas Cu or Cu/Cr catalysts require higher temperatures, of typically from 100 to 140° C.

Hydrogenation to give the resins of the invention may take place in batch or continuous mode. Also possible is a semibatch mode in which resin and/or solvent are supplied continuously to a reactor and/or one or more reaction products and/or solvents are removed continuously.

The space velocity over the catalyst is from 0.05 to 4 t of resin per cubic meter of catalyst per hour, preferably from 0.1 to 2 t of resin per cubic meter of catalyst per hour.

In order to control the temperature profile in the reactor and especially in order to limit the maximum temperature there are a variety of suitable methods known to the skilled worker. Thus, for example, in the case of sufficiently low resin concentrations, reaction may take place entirely without additional reactor cooling, the reaction medium taking up all of the energy released and conveying it out of the reactor by convection. Additionally suitable, for example, are tray reactors with intermediate cooling, the use of hydrogen circuits with gas cooling, the recycling of some of the cooled product (circulation reactor), and the use of external cooling circuits, particularly in the case of tube bundle reactors.

### Preferred Embodiment for Preparing the Carbonyl-Hydrogenated Resins

The hydrogenation of the carbonyl-containing resin A) prepared is carried out in continuous fixed bed reactors. Particularly appropriate for preparing the resins of the invention are shaft ovens and tube bundles, operated preferably in trickle mode. In this case hydrogen and the resin for hydrogenation, if desired in solution in a solvent, are fed in at the top of the reactor onto the catalyst bed. Alternatively the hydrogen can also be passed in countercurrent from bottom to top. The solvent present if desired can then—if desired—be separated off.

### Analytical Methods

### Determination of Free Formaldehyde Content

The formaldehyde content is determined by post-column derivatization by the lutidine method, by means of HPLC.

### Determination of Hydroxyl Number

This is determined by a method based on DIN 53240-2 “Determination of hydroxyl number”.

It should be ensured here that an acetylation time of 3 h exactly is observed.

### Determination of Carbonyl Number

This is determined by FT-IR spectroscopy after calibration with 2-ethylhexanone in THF in a NaCl cell.

### Determining the Nonvolatiles Content (NVC)

The amount of nonvolatile fractions is reported as an average value from a duplicate determination. Approximately 2 g of sample (mass m₂ of substance) are weighed out on an analytical balance into a cleaned aluminum dish (tare mass m₁). Subsequently the aluminum dish is placed in a circulated-air heating cabinet at 150° C. for 24 h. The dish is cooled to room temperature and reweighed to a precision of 0.1 mg (m₃). The nonvolatiles content (NVC) is calculated using the following equation:

$$N V C = \frac{{m}_{3} - {m}_{1}}{{m}_{2}} \cdot 100 [ \% by mass ]$$

### Determination of Gardner Color Number

The Gardner color number is determined in 50% strength solution of the resin in ethyl acetate in a method based on DIN ISO 4630.

The color number is likewise determined after thermal exposure. For this purpose the resin is first stored in an air atmosphere at 150° C. for 24 h (see Determination of nonvolatiles content). After that the Gardner color number is determined in 50% strength solution of the thermally exposed resin in ethyl acetate in a method based on DIN ISO 4630.

### Determination of Solution Viscosity

To determine the solution viscosity the resin is dissolved 40% in phenoxyethanol. The viscosity is measured at 20° C. using a plate/cone rotational viscometer (1/40 s).

### Determination of Polydispersity

The molecular weight distribution of the resins of the invention is measured by means of gel permeation chromatography in tetrahydrofuran against polystyrene standards. The polydispersity (Mw/Mn) is calculated from the ratio of the weight average (Mw) to the number average (Mn).

### Determination of Melting Range

The determination is made using a capillary melting point measurement instrument (Büchi B-545) in a method based on DIN 53181.

### Determination of Amount of Crystallizable Compounds

Solutions of the hydrogenated resins in phenoxyethanol are stored for crystal formation. The crystals are separated off in dilution with ethanol, isolated on a membrane filter, and weighed.

### Calculation of Copolymer Distribution

The procedure used for calculating the values of k, l, and m is as follows:

### Calculation Example

### Whole Numbers Used for the Purpose of Illustration

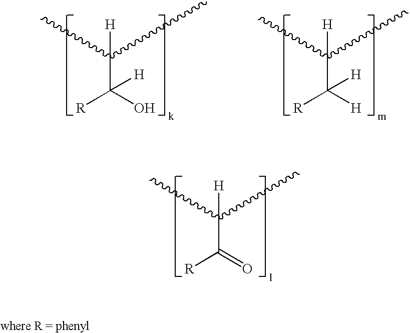

### Assumptions:

The molecular weight (Mn) is taken to be 1000 g/mol, the OH number 300 mg KOH/g, and the carbonyl number 10 mg KOH/g.

An OH number of 300 mg KOH/g results in (300/56110*1000) 5.35 OH groups per 1000 g/mol. This means that k=5.35.

A C═O number of 10 mg KOH/g results in (10/56110*1000) 0.18 C═O groups per 1000 g/mol. This means that l=0.18.

Calculation of m: (1000 g/mol−(5.35 mol*134 g/mol)−(0.18 mol*132 g/mol))/118 g/mol=259/118=2.2

The sum of k+m+l is therefore 5.35+2.2+0.18=7.73

The examples which follow are intended to illustrate the invention but not to restrict its scope of application.

### EXAMPLES

### Noninventive, Comparative Examples

The document that best describes the prior art is DE 33 34 631 A1.

The acetophenone/formaldehyde resin used here was obtained in accordance with Example 2 of DE 892 974.

### Example A

### Reworking of Example 2 of DE 892 974

Following the addition of 240 g of 50% strength potassium hydroxide solution and 400 g of methanol, 1200 g of acetophenone are admixed with 1000 g of 30% strength formaldehyde solution over 2 h with vigorous stirring. In the course of this addition the temperature rises to 90° C. This temperature is maintained for 10 h. The reaction mixture is acidified with sulfuric acid and the condensation product formed is washed with hot water, melted and dewatered under reduced pressure.

This gives 1260 g of a yellow resin. The resin is clear and brittle and possesses a melting point of 67° C. The Gardner color number is 3.8 (50% in ethyl acetate). The resin is soluble in, for example, acetates such as butyl acetate and ethyl acetate and in aromatics such as toluene and xylene. It is insoluble in ethanol. The formaldehyde content is 255 ppm.

### Example B

### Reworking of Example 3 of DE 33 34 631 A1

In accordance with Example 3 of DE 33 34 631 A1 the resin obtained from Example A was hydrogenated at 300 bar and 180° C. continuously in a trickle bed reactor. The reactor was packed with 100 ml of Harshaw-Ni-5124 catalyst (obtainable from Engelhard Corp.). 50 ml/h of a 30% strength solution of the resin in isobutanol were run in, the pressure in the reactor being maintained at a constant 300 bar by introduction of hydrogen to replace that consumed.

### INVENTIVE EXAMPLES

### Inventive example I

### Preparation of a Base Resin for Further Hydrogenation, Based on Acetophenone and Formaldehyde

1200 g of acetophenone, 220 g of methanol, 0.3 g of benzyltributylammonium chloride, and 360 g of a 30% strength aqueous formaldehyde solution are charged to a vessel and homogenized with stirring. Then 32 g of 25% strength aqueous sodium hydroxide solution are added with stirring. Then, still with stirring, at 80 to 85° C., 655 g of a 30% strength aqueous formaldehyde solution are added over 90 minutes. The stirrer is switched off after 5 h of stirring at reflux temperature and the aqueous phase is separated from the resin phase. The crude product is washed with water acidified with acetic acid until a melt sample of the resin appears clear. The resin is then dried by distillation.

This gives 1270 g of a pale yellowish resin. The resin is clear and brittle and possesses a melting point of 72° C. The Gardner color number is 0.8 (50% in ethyl acetate). The resin is soluble in, for example, acetates such as butyl acetate and ethyl acetate and in aromatics such as toluene and xylene. It is insoluble in ethanol. The formaldehyde content is 35 ppm.

Hydrogenation of the Resin Based on Acetophenone and Formaldehyde from Example I)

### Inventive Example 1

300 g of the resin from Example I) are dissolved with heating in 700 g of isobutanol. The hydrogenation then takes place at 260 bar and 120° C. in an autoclave (Parr) with a catalyst basket filled with 100 ml of a Raney-type nickel catalyst. After 8 h the reaction mixture is discharged from the reactor via a filter.

### Inventive Example 2

300 g of the resin from Example I) are dissolved in 700 g of tetrahydrofuran (water content approximately 7%). The hydrogenation then takes place at 260 bar and 120° C. in an autoclave (Parr) with a catalyst basket filled with 100 ml of a commercially customary Ru catalyst (3% Ru on alumina). After 20 h the reaction mixture is discharged from the reactor via a filter.

### Inventive Example 3

The resin from Example I) is dissolved 30% in isobutanol, with heating. The hydrogenation takes place in a continuously operated fixed bed reactor packed with 400 ml of a commercially customary, silica-supported copper-chromium catalyst. At 300 bar and 130° C. 500 ml/h or the reaction mixture are passed through the reactor from top to bottom (trickle mode). The pressure is held constant by introducing further hydrogen.

### Inventive Example 4

The resin from Example I) is dissolved 30% in isobutanol, with heating. The hydrogenation takes place in a continuously operated fixed bed reactor packed with 400 ml of a commercially customary, Raney-type nickel catalyst. At 300 bar and 130° C. 400 ml/h of the reaction mixture are passed through the reactor from top to bottom (trickle mode). The pressure is held constant by introducing further hydrogen.

The resin solutions from inventive Examples 1 to 4 and comparative Example B are freed from the solvent under reduced pressure. The properties of the resultant resins are listed in Table 1.

TABLE 1
Properties of the hydrogenated resins of inventive Examples 1 to 4

| | Comp. Ex. B | Resin 1 | Resin 2 | Resin 3 | Resin 4 |
|---|---|---|---|---|---|
| Free formaldehyde content [ppm] | 6.0 | 1.2 | 1.1 | <1 | 1.3 |
| Amount of crystallizable compounds | 5.4 | <0.1 | <0.1 | <0.1 | <0.1 |
| [% by weight] | | | | | |
| Carbonyl number [mg KOH/g] | 24.3 | 14.9 | 5.8 | 2.5 | 5.2 |
| Hydroxyl number [mg KOH/g] | 210 | 295 | 315 | 335 | 317 |
| Melting point [° C.] | 92 | 109 | 114 | 124 | 118 |
| Nonvolatiles content | 99.6 | 99.7 | 99.6 | 99.5 | 99.7 |
| (24 h at 150° C.) [% by mass] | | | | | |
| Gardner color number (50% in ethyl | 2.2 | 0.4 | 0.2 | 0.1 | 0.1 |
| acetate) | | | | | |
| Gardner color number | 3.1 | 0.6 | 0.3 | 0.2 | 0.2 |
| (after thermal exposure for 24 h at | | | | | |
| 150° C.; 50% in ethyl acetate) | | | | | |
| Viscosity (40% in phenoxyethanol) | 6.800 | 6.600 | 7.300 | 8.600 | 7.900 |
| Mn (GPC against PS) | 910 | 980 | 1000 | 1070 | 1040 |
| Mw (GPC against PS) | 1570 | 1490 | 1430 | 1550 | 1530 |
| Polydispersity | 1.73 | 1.52 | 1.43 | 1.45 | 1.47 |
| k | 3.4 | 5.2 | 5.6 | 6.4 | 5.9 |
| l | 0.4 | 0.3 | 0.1 | 0.1 | 0.1 |
| m | 3.4 | 2.2 | 1.2 | 1.8 | 2.0 |
| k + l + m | 7.2 | 7.6 | 7.7 | 8.2 | 8.0 |

All of the resins are soluble in typical paint solvents. In contrast to the base resin from Example I) the resins are now soluble in polar solvents such as alcohols. By way of example the resins are soluble in ethanol, dichloromethane, ethyl acetate, butyl acetate, isopropanol, acetone, and diethyl ether.

As compared with the noninventive resin of Example B the inventive resins 1 to 4 possess a lower free formaldehyde content and a reduced amount of crystallizable compounds. Corresponding to the lower carbonyl number, the color number is lower both before and after thermal exposure. Despite the fact that these resins have melting points up to 35% higher than the noninventive resin of Example B, the viscosity is of comparable magnitude to that of the resin of Example B. This can be explained where appropriate by the higher polydispersity of the noninventive resin.

The resins of Examples 1-4 are soluble in ethanol in any proportion. In contrast, the resin from the comparative example is no longer infinitely soluble in ethanol at concentrations below 10% solids.

1: A carbonyl-hydrogenated ketone-aldehyde resin based on formaldehyde, having a free formaldehyde content of less than 3 ppm, comprising the structural elements of formula II 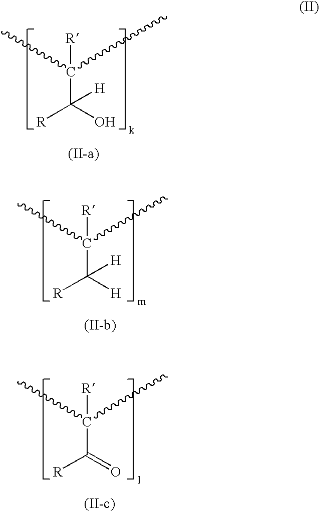
where
R is aromatic with 6-14 carbon atoms or (cyclo)aliphatic with 1-12 carbon atoms,
R′ is H or CH₂OH,
k is 2 to 15,
m is 0 to 13,
l is 0 to 2,
the sum of k+l+m being from 5 to 15 and k being >m, the three structural elements possibly being distributed alternately or randomly, and the structural elements being linked linearly via CH₂ groups and/or with branching via CH groups.

2: The carbonyl-hydrogenated ketone-aldehyde resin based on formaldehyde according to claim 1,
obtained by
A) preparing the base resin by condensing at least one ketone with at least one aldehyde in the presence of at least one basic catalyst and, optionally, of at least one phase transfer catalyst, solventlessly or using a water-miscible organic solvent,
and subsequently
B) subjecting the carbonyl groups of the ketone-aldehyde resin (A) to continuous, semibatchwise or batchwise hydrogenation in the melt or in solution in a suitable solvent with hydrogen in the presence of a catalyst at pressures from 50 to 350 bar, and at temperatures from 40 to 140° C.

3: The carbonyl-hydrogenated ketone-aldehyde resin according to claim 1,
characterized in that
the free formaldehyde content is below 3 ppm,
the amount of crystallizable compounds is below 5% by weight,
the carbonyl number is from 0 to 100 mg KOH/g,
the hydroxyl number is from 50 to 450 mg KOH/g,
the Gardner color number (50% in ethyl acetate) is below 1.5,
the Gardner color number (50% in ethyl acetate) after thermal exposure of the resin (24 h, 150° C.) is below 2.0,
the polydispersity (Mw/Mn) of the resin is from 1.35 to 1.6,
the solution viscosity, 40% strength in phenoxyethanol, is from 5000 to 12 000 mPa·s,
the melting point/range is from 50 to 150° C., and
the amount of nonvolatile constituents after heating at 150° C. for 24 h is more than 97.0%.

4: The carbonyl-hydrogenated ketone-aldehyde resin according to claim 1, characterized in that
the ketone-aldehyde resin is prepared using α-methyl ketones possessing no reaction facility in the position α′ to the carbonyl group or exhibiting only low reactivity in the α′ position.

5: The carbonyl-hydrogenated ketone-aldehyde resin according to claim 1, characterized in that
acetophenone, acetophenone derivatives, alkyl-substituted acetophenone derivatives having 1 to 8 carbon atoms on the phenyl ring, methoxyacetophenone, 3,3-dimethylbutanone, methyl isobutyl ketone or propiophenone, alone or in a mixture, are used as starting bonds for preparing the ketone-aldehyde resin, in amounts of 70 to 100 mol %, based on the ketone component.

6: The carbonyl-hydrogenated ketone-aldehyde resin according to claim 1, characterized in that
up to 30 mol %, based on the ketone component, of C—H— acidic ketones selected from acetone, methyl ethyl ketone, heptan-2-one, pentan-3-one, cyclopentanone, cyclododecanone, mixtures of 2,2,4- and 2,4,4-trimethylcyclopentanone, cycloheptanone, cyclooctanone, cyclohexanone and all alkyl-substituted cyclohexanones having one or more alkyl radicals which have in total 1 to 8 hydrocarbon atoms, alone or in mixtures, are used as starting bonds for preparing the ketone-aldehyde resin.

7: The carbonyl-hydrogenated ketone-aldehyde resin according to claim 1, characterized in that
up to 30 mol %, based on the ketone component, of C—H— acidic ketones are used as starting bonds for preparing the ketone-aldehyde resin, selected from cyclohexanone, methyl ethyl ketone, 2-tert-butylcyclohexanone, 4-tert-butylcyclohexanone and/or 3,3,5-trimethyl-cyclohexanone.

8: The carbonyl-hydrogenated ketone-aldehyde resin according to claim 1, characterized in that
formaldehyde and/or formaldehyde donor compounds are used as starting compounds for preparing the ketone-aldehyde resin.

9: The carbonyl-hydrogenated ketone-aldehyde resin according to claim 1, characterized in that
formaldehyde and/or para-formaldehyde and/or trioxane are used as starting compounds for preparing the ketone-aldehyde resin.

10: The carbonyl-hydrogenated ketone-aldehyde resin according to claim 1, characterized in that,
further to formaldehyde, aldehydes selected from acetaldehyde, n-butyraldehyde, isobutyraldehyde, valeraldehyde, dodecanal, alone or in mixtures in fractions from 0 to 75 mol %, based on the aldehyde component, are used as starting compounds for preparing the ketone-aldehyde resin.

11: The carbonyl-hydrogenated ketone-aldehyde resin according to claim 1, characterized in that
acetophenone, 3,3-dimethylbutanone and/or methyl isobutyl ketone and, optionally, CH-acidic ketones selected from cyclohexanone, methyl ethyl ketone, 2-tert-butylcyclohexanone, 4-tert-butylcyclohexanone, and 3,3,5-trimethyl-cyclohexanone, alone or in a mixture, and formaldehyde are used as starting compounds for preparing the ketone-aldehyde resin.

12: The carbonyl-hydrogenated ketone-aldehyde resin according to claim 1, characterized in that
the molar ratio of the ketone to the aldehyde component is from 1:0.25 to 1:15.

13: A process for preparing a carbonyl-hydrogenated ketone-aldehyde resin having a free formaldehyde content of less than 3 ppm according to at claim 1, which comprises,
A) preparing the base resin by condensing at least one ketone with at least one aldehyde in the presence of at least one basic catalyst and, optionally, of at least one phase transfer catalyst, solventlessly or using a water-miscible organic solvent,
and subsequently
B) subjecting the carbonyl groups of the ketone-aldehyde resin (A) to continuous, semibatchwise or batchwise hydrogenation in the melt or in solution in a suitable solvent with hydrogen in the presence of a catalyst at pressures from 50 to 350 bar, and at temperatures from 40 to 140° C.

14: The process according to claim 13,
characterized in that reaction A) is carried out in a basic medium.

15: The process according to claim 14,
characterized in that hydroxides of the cations NH₄, NR₄, Li, Na or K are used as basic catalysts for preparing the carbonyl-containing ketone-aldehyde resin A).

16: The process according to claim 13, characterized in that the carbonyl-containing ketone-aldehyde resin A) is prepared using auxiliary solvent.

17: The process according to claim 16, characterized in that the carbonyl-containing ketone-aldehyde resin A) is prepared using auxiliary solvent selected from water-miscible alcohols and/or ketones.

18: The process according to claim 13, characterized in that
the carbonyl-containing ketone-aldehyde resin A) is prepared additionally using a phase transfer catalyst in amounts from 0.01% to 15%, by weight, based on the ketone employed, in the polycondensation mixture.

19: The process according to claim 18,
characterized in that
cetyldimethylbenzylammonium chloride, benzyltributylammonium chloride and/or triethylbenzylammonium chloride are used as quaternary ammonium salts and triphenylbenzylphosphonium chloride and/or triphenylbenzylphosphonium iodide are used as quaternary phosphonium salts.

20: The process according to claim 13,
characterized in that
the base resin A) is purified by washing with water using acids.

21: The process according to claim 20,
characterized in that
the base resin A) is purified by washing with water using organic acids having 1 to 6.

22: The process for preparing a carbonyl-hydrogenated ketone-aldehyde resin, according to claim 13,
characterized in that
a heterogeneous catalyst is used for hydrogenating the carbonyl-containing base resin A).

23: The process for preparing a carbonyl-hydrogenated ketone-aldehyde resin, according to claim 13,
characterized in that
metal catalysts are used for the hydrogenation.

24: The process for preparing a carbonyl-hydrogenated ketone-aldehyde resin, according to claim 13,
characterized in that
metal catalysts are used for the hydrogenation that contain the metals nickel, copper, copper-chromium, palladium, platinum, ruthenium, and rhodium, alone or in mixtures.

25: The process for preparing a carbonyl-hydrogenated ketone-aldehyde resin, according to claim 13,
characterized in that
the metal catalysts further contain doping metals and/or other modifiers.

26: The process for preparing a carbonyl-hydrogenated ketone-aldehyde resin, according to claim 25,
characterized in that
additional doping metals are present, selected from Mo, Fe, Ag, Cr, Ni, V, Ga, In, Bi, Ti, Zr, and Mn, and also from the rare earths.

27: The process for preparing a carbonyl-hydrogenated ketone-aldehyde resin, according to claim 13,
characterized in that
modifiers are present selected from alkali metals and alkaline earth metals and/or compounds thereof, and/or phosphoric acid and/or sulfuric acid and compounds thereof.

28: The process for preparing a carbonyl-hydrogenated ketone-aldehyde resin, according to claim 13,
characterized in that
the catalysts are used in the form of powders or shaped bodies.

29: The process for preparing a carbonyl-hydrogenated ketone-aldehyde resin, according to claim 13,
characterized in that
the catalysts are used in the form of solid catalysts, Raney-type catalysts or supported catalysts.

30: The process for preparing a carbonyl-hydrogenated ketone-aldehyde resin, according to claim 29,
characterized in that
kieselguhr, silica, alumina, aluminosilicates, titanium dioxide, zirconium dioxide, aluminum-silicon mixed oxides, magnesium oxide and/or activated carbon are used as support material.

31: The process for preparing a carbonyl-hydrogenated ketone-aldehyde resin, according to claim 13,
characterized in that
the catalytic hydrogenation is carried out in the melt, in solution in a suitable solvent or in the hydrogenation product itself as “solvent”.

32: The process for preparing a carbonyl-hydrogenated ketone-aldehyde resin, according to claim 31,
characterized in that
n-butanol, isobutanol, tetrahydrofuran, ethyl acetate, butyl acetate, xylene, dioxane, diethyl ether and/or diethylene glycol are used as solvents.

33: The process for preparing a carbonyl-hydrogenated ketone-aldehyde resin, according to claim 31,
characterized in that
the solvent present is separated off after the end of reaction and recycled to the circuit.

34. (canceled)

35: The process for preparing a carbonyl-hydrogenated ketone-aldehyde resin, according to claim 13,
characterized in that
the space velocity over the catalyst is from 0.05 to 4 t of resin per cubic meter of catalyst per hour.

36: The process for preparing a carbonyl-hydrogenated ketone-aldehyde resin, according to claim 13,
characterized in that
the hydrogenation takes place batchwise, continuously or semibatchwise.

37: The process for preparing a carbonyl-hydrogenated ketone-aldehyde resin, according to claim 13,
characterized in that
the hydrogenation takes place continuously.

38: The process for preparing a carbonyl-hydrogenated ketone-aldehyde resin, according to claim 13,
characterized in that
hydrogenation takes place in a fixed bed reactor.

39: The process for preparing a carbonyl-hydrogenated ketone-aldehyde resin, according to claim 13,
characterized in that
hydrogenation takes place in shaft ovens or tube bundles.

40: The process for preparing a carbonyl-hydrogenated ketone-aldehyde resin, according to claim 13,
characterized in that
hydrogenation takes place in trickle mode.

41: The process for preparing a carbonyl-hydrogenated ketone-aldehyde resin, according to claim 13,
characterized in that
hydrogen and the resin for hydrogenation, optionally in solution in a solvent, is fed in at the top of the reactor onto the catalyst bed.

42: The process for preparing a carbonyl-hydrogenated ketone-aldehyde resin, according to claim 13,
characterized in that
the hydrogen is passed counter currently from bottom to top.

43: The process for preparing a carbonyl-hydrogenated ketone-aldehyde resin based on formaldehyde, according to claim 13,
characterized in that
first of all the carbonyl-containing base resin A) is prepared, by
introducing and homogenizing 10 mol (or a multiple) of a ketone in a 50% to 90% strength methanolic solution, 0 to 5% by mass of a phase transfer catalyst, and 1 to 5 mol (or a multiple) of an aqueous formaldehyde solution, with stirring,
adding from 0.1 to 5 mol (or a multiple) of an aqueous sodium hydroxide solution with stirring,
adding from 4 to 10 mol (or a multiple) of an aqueous formaldehyde solution at 70 to 115° C. with stirring over 30 to 120 min,
switching off the stirrer after a further 0.5 to 5 h of stirring at reflux temperature, and optionally adding, after about a third of the operating time, a further 0.1 to 1 mol of an aqueous formaldehyde solution,
separating the aqueous phase from the resin phase,
washing the crude product with water, using an organic acid, until a melt sample of the resin appears clear, and
finally drying the resin by distillation.
